(19) United States
(12) Patent Application Publication
(10) Pub. No.: US 2024/0255694 A1
(43) Pub. Date: Aug. 1, 2024

(54) SINGLE-MODE OPTICAL FIBERS WITH LOW CUTOFF WAVELENGTH AND LOW BEND LOSS

(71) Applicant: CORNING INCORPORATED, CORNING, NY (US)

(72) Inventors: Scott Robertson Bickham, Corning, NY (US); Martin Hempstead, Painted Post, NY (US); Snigdharaj Kumar Mishra, Wilmington, NC (US); Stephen Quenton Smith, Lawrenceville, PA (US); Pushkar Tandon, Painted Post, NY (US)

(21) Appl. No.: 18/411,175

(22) Filed: Jan. 12, 2024

Related U.S. Application Data
(60) Provisional application No. 63/441,898, filed on Jan. 30, 2023.

(51) Int. Cl. G02B 6/028; G02B 6/02

(52) U.S. Cl. CPC G02B 6/0281; G02B 6/02009

(57) ABSTRACT

An optical fiber having a silica-based core region with an outer radius r₁ from about 4.0 microns to about 4.6 microns and a core volume from about 4.5% Δ-micron² to about 5.5% Δ-micron². The optical fiber further includes a depressed-index cladding region and an outer cladding region. The depressed-index cladding region having an inner radius r₂ such that r₁/r₂ is greater than about 0.4 and less than about 0.6 and a trench volume between about −50% Δ-micron²s and about −20% Δ-micron². The optical fiber has a mode field diameter at 1310 nm from about 8.8 microns to about 9.4 microns, a 2 m cable cutoff from about 1120 nm to about 1260 nm, a bending loss at 1310 nm, as determined by the mandrel wrap test using a 15 mm diameter mandrel, of less than 1.0 dB/turn, and a zero dispersion wavelength between 1300 nm and 1324 nm.

This application claims the benefit of priority under 35 U.S.C § 120 of U.S. Provisional Application Ser. No. 63/441,898 filed on Jan. 30, 2023, the content of which is relied upon and incorporated herein by reference in its entirety.

### FIELD

The present disclosure relates to optical fibers with low cutoff wavelengths and low bend loss, and in particular, to single-mode optical fibers for short-length applications such as co-packaged optics.

### BACKGROUND

In current data-center switches, external fiber optic connections terminate at pluggable transceivers connected to a housing. Optical signals are then electrically transported from the transceivers via copper traces on printed circuit boards. However, with increasing data rates, these electrical connections are becoming unsuitable to transport the number of optical signals being utilized. To address this problem, the industry is turning to co-packaged optics in which the transceiver is positioned inside the housing very close to the location of signal generation within the housing. This approach effectively replaces the high-loss copper traces with low-loss optical fiber. However, to achieve such low-loss optical connectivity, the optical fibers must be single-mode for short applications (about 0.5 m lengths) to avoid introducing signal impairments due to multi-path interference. It is also desirable that the optical fibers have good bend performance and mode-field diameters that are compatible with the installed base of standard single-mode fibers and/or readily available single-mode fibers.

### SUMMARY

Co-packaged optics for data centers represent a paradigm shift that introduces several new connectivity challenges. Such challenges include routing constraints and a need for the low-loss connection of hundreds of optical fibers in the confined space of a switch housing. For example, in a 51.2 Terabit per second switch housing with four optical 100 Gigabit per second lanes per fiber, 256 optical connections must be made between the transceivers and the faceplate of the switch box. Thus, the optical fibers need to satisfy the requirements of having: (i) low enough cutoff wavelength to ensure single-mode operation and low multipath interference in the O-band (1260 nm to 1360 nm) for short-length applications, (ii) a mode field diameter at 1310 nm of about 9 microns to ensure backward-compatibility with the installed base of standard single-mode fibers and/or readily available single-mode fibers, and (iii) low bend-loss in the O-band to enable tight routing of the fibers in constrained spaces with bend diameters less than 15 mm.

Embodiments of the present disclosure comprise optical fibers optimized for co-packaged applications.

An aspect of the present disclosure is an optical fiber comprising a silica-based core region comprising an alpha value less than 20, an outer radius r₁ from about 4.0 microns to about 4.6 microns, a maximum relative refractive index Δ_{IMAX} from about 0.28% to about 0.40%, and a core volume from about 4.5% Δ-micron² to about 5.5% Δ-micron². The optical fiber further comprises a depressed-index cladding region surrounding the core region and an outer cladding region surrounding the depressed-index cladding region. The depressed-index cladding region comprising an inner radius r₂ such that r₁/r₂ is greater than about 0.4 and less than about 0.6, an outer radius r₃, a minimum relative refractive index Δ_{3MIN} less than about −0.2%, and a trench volume between about −50% Δ-micron² and about −20% Δ-micron². The outer cladding region comprising an outer radius r₄. The optical fiber has a mode field diameter at 1310 nm from about 8.8 microns to about 9.4 microns, a 2 m cable cutoff from about 1120 nm to about 1260 nm, a bending loss at 1310 nm, as determined by the mandrel wrap test using a mandrel comprising a diameter of 15 mm, of less than 1.0 dB/turn, and a zero dispersion wavelength between 1300 nm and 1324 nm.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a schematic view of a cross-section of a coated optical fiber according to embodiments of the present disclosure;

FIG. 2 is a schematic view of a cross-section of an optical fiber according to embodiments of the present disclosure;

FIG. 3 depicts a relative refractive index profile of an optical fiber according to embodiments of the present disclosure;

FIGS. 4 and 5 depict relative refractive index profiles of optical fibers according to exemplary embodiments of the present disclosure;

FIG. 6 depicts a plot of cable cutoff vs. fiber length of exemplary and comparative fibers;

FIGS. 7-10 depict relative refractive index profiles of optical fibers according to exemplary embodiments of the present disclosure;

FIG. 11 is a schematic showing multipath interference in three optical fibers with offset connections;

FIG. 12 is a schematic of an experimental set-up for determining multi-path interference;

FIG. 13 depicts a plot of output power as a function of wavelength of a comparative fiber as measured using the set-up shown in FIG. 12;

FIG. 14 depicts a plot of output power as a function of wavelength of another comparative fiber as measured using the set-up shown in FIG. 12;

FIG. 15 depicts a plot of output power as a function of wavelength of another comparative fiber as measured using the set-up shown in FIG. 12;

FIG. 16 depicts a plot of output power as a function of wavelength of an exemplary fiber according to exemplary embodiments of the present disclosure as measured using the set-up shown in FIG. 12;

FIG. 17 is a close-up, side view of an example integrated system that utilizes the optical fibers disclosed herein; and

FIG. 18 is a schematic diagram of an example optical communication system that includes the integrated system of FIG. 17 operably connected to a remote device, wherein the optical system is shown by way of example as being deployed in a data center.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, reference will be made to a number of terms which shall be defined to have the following meanings:

“Optical fiber” refers to a waveguide having a glass portion surrounded by a coating. The glass portion includes a core and a cladding and is referred to herein as a “glass fiber”.

“Radial position”, “radius”, or the radial coordinate “r” refers to radial position relative to the centerline (r=0) of the fiber.

“Refractive index” refers to the refractive index at a wavelength of 1550 nm, unless otherwise specified.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ%) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined by equation (1) below, unless otherwise specified. Whether by design or a consequence of normal manufacturing variability, the dependence of relative refractive index on radial position may be sloped, curved, or otherwise non-constant.

“Relative refractive index,” as used herein, is defined in equation (1) as:

$${Δ}_{i} ( {r}_{i} ) \% = 100 \frac{( {n}_{i}^{2} - {n}_{ref}^{2} )}{2 {n}_{i}^{2}} \qquad ( 1 )$$

where nᵢ is the refractive index at radial position r₁ in the glass fiber, unless otherwise specified, and n_{ref} is the refractive index of pure silica glass, unless otherwise specified. Accordingly, as used herein, the relative refractive index percent is relative to pure silica glass, which has a value of 1.444 at a wavelength of 1550 nm. As used herein, the relative refractive index is represented by Δ (or “delta”) or Δ% (or “delta %) and its values are given in units of “%”, unless otherwise specified. Relative refractive index may also be expressed as Δ(r) or Δ(r) %.

The average relative refractive index (Δₐᵥₑ) of a region of the fiber is determined from equation (2):

$${Δ}_{ave} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, router is the outer radius of the region, and Δ(r) is the relative refractive index of the region.

The refractive index of an optical fiber profile may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)−nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined by equation (1).

The term “α-profile” or “alpha profile” refers to a relative refractive index profile Δ(r) that has the functional form defined in equation (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, Δ(r₀)>0, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and α is a real number. Δ(r₀) for an α-profile may be referred to herein as Amax or, when referring to a specific region i of the fiber, as Δᵢₘₐₓ. When the relative refractive index profile of the fiber core region is described by an α-profile with r₀ occurring at the centerline (r=0), r_{z} corresponding to the outer radius r₁ of the core region, and Δ₁(r₁)=0, equation (3) simplifies to equation (4):

$${Δ}_{1} ( r ) = {Δ}_{1 max} [ 1 - {[ \frac{r}{{r}_{1}} ]}^{α} ] \qquad ( 4 )$$

When the core region has an index described by equation (4), the outer radius r₁ can be determined from the measured relative refractive index profile by the following procedure. Estimated values of the maximum relative refractive index Δ₁ₘₐₓ, «, and outer radius r₁ₑₛₜ are obtained from inspection of the measured relative refractive index profile and used to create a trial function Δₜᵣᵢₐₗ between r=0 and r=r₁ₑₛₜ. The sum of the squares of the difference between the trial function and the measured profile (Δₘₑₐₛ), λ²=Σ(Δₜᵣᵢₐₗ−Δₘₑₐₛ)², is minimized over values of r ranging between 0.1 r₁ₑₛₜ and 0.95 r₁ₑₛₜ using the Nelder-Mead algorithm (Nelder, John A. and R. Mead, “A simplex method for function minimization,” Computer Journal 7: 308-313 (1965)) to determine Δ₁ₘₐₓ, α, and r₁. A relative refractive index profile of representative glass fibers having cores described by an α-profile, in accordance with embodiments of the present disclosure, is shown in FIG. 3.

The “core volume” V₁ is defined as:

$${V}_{1} = 2 {\int }_{0}^{{r}_{1}} {Δ}_{1} ( r ) rdr \qquad ( 5 )$$

where r₁ is the outer radius of the refractive index profile of the core region, Δ₁(r) is the relative refractive index of the core region of the refractive index profile, and r is radial position in the fiber. The core volume V₁ is a positive quantity and will be expressed herein in units of % Δ-μm², which may also be expressed as % Δμm² or % Δ-micron², or % Δ-sq. microns.

“Trench volume” is defined as:

$${V}_{Trench} = \vert 2 {\int }_{{r}_{Trench , inner}}^{{r}_{Trench , outer}} {Δ}_{Trench} ( r ) rdr \vert \qquad ( 6 )$$

where r_{Trench,inner} is the inner radius of the trench region of the refractive index profile, r_{Trench,outer} is the outer radius of the trench region of the refractive index profile, Δ_{Trench}(r) is the relative refractive index of the trench region of the refractive index profile, and r is radial position in the fiber. Trench volume is in absolute value and a positive quantity and will be expressed herein in units of % Δmicron², % Δ-micron², % Δ-μm², or % Δμm², whereby these units can be used interchangeably herein. A trench region is also referred to herein as a depressed-index cladding region and trench volume is also referred to herein as V₃.

The “mode field diameter” or “MFD” of an optical fiber is defined in equation (7) as:

$$MFD = 2 w \qquad ( 7 )$$

$${w}^{2} = 2 \frac{{\int }_{0}^{∞} {( f ( r ) )}^{2} rdr}{{\int }_{0}^{∞} {( \frac{df ( r )}{dr} )}^{2} rdr}$$

where f(r) is the transverse component of the electric field distribution of the guided optical signal and r is radial position in the fiber. “Mode field diameter” or “MFD” depends on the wavelength of the optical signal and is reported herein for wavelengths of 1310 nm, 1550 nm, and 1625 nm. Specific indication of the wavelength will be made when referring to mode field diameter herein. Unless otherwise specified, mode field diameter refers to the LP₀₁ mode at the specified wavelength.

“Effective area” of an optical fiber is defined in equation (8) as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 8 )$$

where f(r) is the transverse component of the electric field of the guided optical signal and r is radial position in the fiber. “Effective area” or “Δ_{eff}” depends on the wavelength of the optical signal and is understood herein to refer to a wavelength of 1550 nm.

The term “attenuation,” as used herein, is the loss of optical power as the signal travels along the optical fiber. Attenuation was measured as specified by the IEC-60793-1-40 standard, “Attenuation measurement methods.”

The bend resistance of an optical fiber, expressed as “bend loss” herein, can be gauged by induced attenuation under prescribed test conditions as specified by the IEC-60793-1-47 standard, “Measurement methods and test procedures—Macrobending loss.” For example, the test condition can entail deploying or wrapping the fiber one or more turns around a mandrel of a prescribed diameter, e.g., by wrapping 1 turn around either a 15 mm, 20 mm, or 30 mm or similar diameter mandrel (e.g. “1×15 mm diameter bend loss” or the “1×20 mm diameter bend loss” or the “1×30 mm diameter bend loss”) and measuring the increase in attenuation per turn.

“Cable cutoff wavelength,” or “cable cutoff,” as used herein, refers to the cable cutoff test specified by the IEC 60796-1-44 standard and is defined as the wavelength at which the second-order modes undergo 19.3 dB more attenuation than the LP01 mode. Two different types of cable cutoff tests are defined in the IEC-60796-1-44 standard: (1) Method A—measuring the cable cutoff on an uncabled fiber; and (2) Method B—measuring the cable cutoff on a cabled fiber. According to the IEC-60796-1-44 standard, the cable cutoffs are measured (for both Methods A and B) on a fiber sample having a length of 22 m with 80 mm diameter loops at both ends. For purposes of the present disclosure, the cable cutoff measurements disclosed herein were conducted using Method A of the IEC 60796-1-44 standard. It is noted that Method A was used to measure the cable cutoff values for 22 m sample lengths as well as for shorter sample lengths of 10 m, 5 m, 2 m, and 1 m, as disclosed herein.

The optical fibers disclosed herein include a core region, a cladding region surrounding the core region, and a coating surrounding the cladding region. The core region and cladding region are glass. The cladding region includes multiple regions. The multiple cladding regions are preferably concentric regions. The cladding region includes an inner cladding region, a depressed-index cladding region, and an outer cladding region. As discussed further below, the depressed-index cladding region may comprise various shapes, such as a square profile or a triangular profile. The inner cladding region surrounds and is directly adjacent to the core region. The depressed-index cladding region surrounds and is directly adjacent to the inner cladding region such that the depressed-index cladding region is disposed between the inner cladding region and the outer cladding region in a radial direction. The outer cladding region surrounds and is directly adjacent to the depressed-index cladding region.

The depressed-index cladding region has a lower relative refractive index than each of the inner cladding region and the outer cladding region. The relative refractive index of the inner cladding region may be less than, equal to, or greater than the relative refractive index of the outer cladding region. The depressed-index cladding region may each be referred to herein as a trench or trench region. Furthermore, the depressed-index cladding region contributes to a reduction in bending losses and microbending sensitivity.

Whenever used herein, radial position r₁ and relative refractive index Δ₁ or Δ₁(r) refer to the core region, radial position r₂ and relative refractive index Δ₂ or Δ₂(r) refer to the inner cladding region, radial position r₃ and relative refractive index Δ₃ or Δ₃(r) refer to the depressed-index cladding region, and radial position r₄ and relative refractive index Δ₄ or Δ₄(r) refer to the outer cladding region. Additionally, a radial position 15 (not shown in FIG. 3) refers to a primary coating, radial position r₆ (not shown in FIG. 3) refers to a secondary coating, and the radial position r₇ (not shown in FIG. 3) refers to an optional tertiary coating.

The relative refractive index Δ₁(r) has a maximum value Δ₁ₘₐₓ and a minimum value Δ₁ₘᵢₙ. The relative refractive index Δ₂(r) has a maximum value Δ₂ₘₐₓ and a minimum value Δ₂ₘᵢₙ. The relative refractive index Δ₃(r) has a maximum value Δ₃ₘₐₓ and a minimum value Δ₃ₘᵢₙ. The relative refractive index Δ₄(r) has a maximum value Δ₄ₘₐₓ and a minimum value Δ₄ₘᵢₙ. In embodiments in which the relative refractive index is constant or approximately constant over a region, the maximum and minimum values of the relative refractive index are equal or approximately equal. Unless otherwise specified, if a single value is reported for the relative refractive index of a region, the single value corresponds to an average value for the region.

It is understood that the central core region is substantially cylindrical in shape and that the surrounding inner cladding region, depressed-index cladding region, outer cladding region, primary coating, and secondary coating are substantially annular in shape. Annular regions are characterized in terms of an inner radius and an outer radius. Radial positions r₁, r₂, r₃, r₄, r₅, r₆, r₇, refer herein to the outermost radii of the core region, inner cladding region, depressed-index cladding region, outer cladding region, primary coating, secondary coating, and tertiary coating, respectively. The radius 16 also corresponds to the outer radius of the optical fiber in embodiments without a tertiary coating. When a tertiary coating is present, the radius r₇ corresponds to the outer radius of the optical fiber.

The difference between radial position 12 and radial position r₁ is the thickness of the inner cladding region. The difference between radial position r₃ and radial position r₂ is the thickness of the depressed-index cladding region. The difference between radial position r₄ and radial position r₃ is the thickness of the outer cladding region. The difference between radial position r₅ and radial position r₄ is the thickness of the primary coating. The difference between radial position r₆ and radial position r₅ is the thickness of the secondary coating.

Reference will now be made in detail to illustrative embodiments of the present description.

One embodiment relates to an optical fiber. The optical fiber includes a glass fiber surrounded by a coating. An example of an optical fiber is shown in schematic cross-sectional view in FIG. 1. Optical fiber 10 includes glass fiber 20 surrounded by primary coating 50 and secondary coating 60. Glass fiber 20 includes a core region 30 and a cladding region 40. In some embodiments, secondary coating 60 may include a pigment. Further description of glass fiber 20, primary coating 50, and secondary coating 60 is provided below. Additionally, one or more tertiary ink layers may surround secondary coating 60.

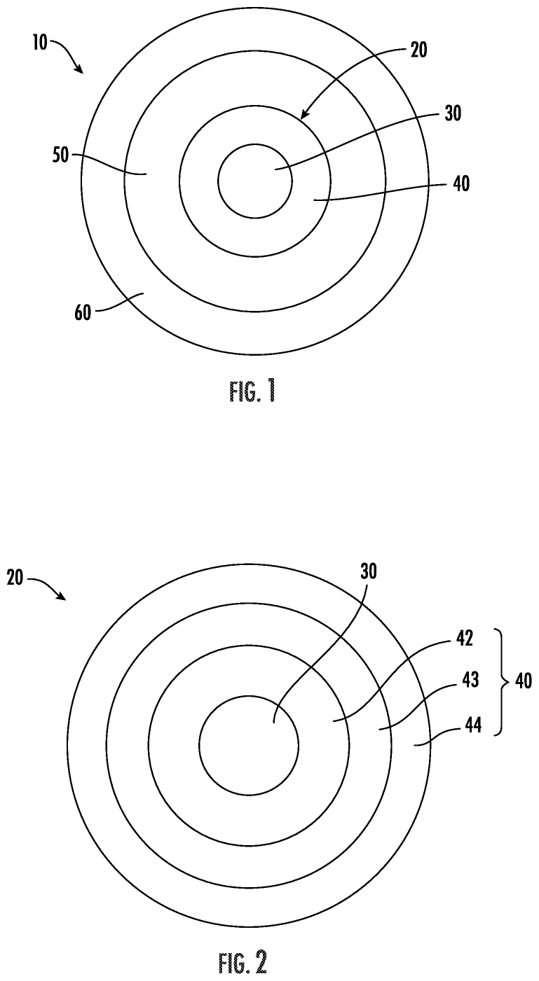

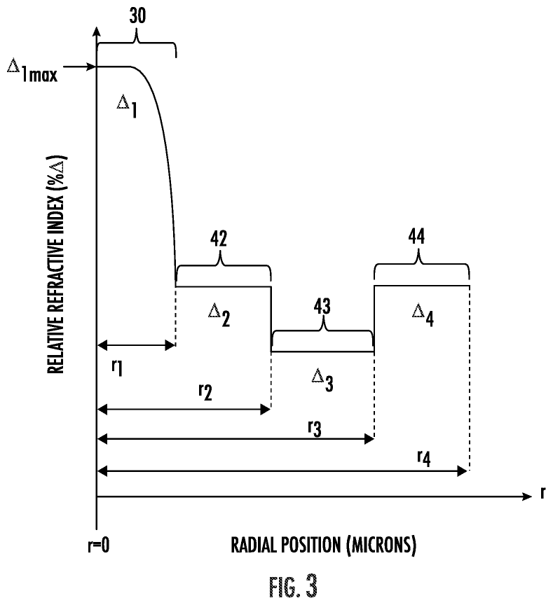

A schematic cross-sectional depiction of glass fiber 20 is shown in FIG. 2. As shown in FIG. 2, cladding region 40 surrounds core region 30. Core region 30 has a higher refractive index than cladding region 40, and glass fiber 20 functions as a waveguide. In some embodiments, core region 30 and cladding region 40 have a discernible core-cladding boundary. Alternatively, core region 30 and cladding region 40 can lack a distinct boundary. Furthermore, cladding region 40 comprises inner cladding region 42, depressed-index cladding region 43, and outer cladding region 44.

FIG. 3 plots an idealized relative refractive index profile of glass fiber 20 as the relative refractive index Δ versus the radial coordinate r. Core region 30 has relative refractive index Δ1, with a maximum refractive index of Δ₀=Δ1_{MAX} at r=0 and a gradient α-profile, which is described in greater detail below. Inner cladding region 42 has a relative refractive index Δ2. Depressed-index cladding region 43 can be in the form of a depressed region or a trench and has a relative refractive index Δ3, with a minimum value Δ3_{MIN}. Outer cladding region 44 has a relative refractive index Δ4, which is shown by way of example as Δ4=Δ2. Furthermore, as shown by way of example, Δ3_{MIN}<Δ2 and Δ3_{MIN}<Δ4. Other configurations for the relative refractive index profile are discussed further below.

### Core Region

Core region 30 comprises silica glass that is either un-doped silica glass, up-doped silica glass, and/or down-doped silica glass. Up-doped silica glass includes silica glass doped with, for example, germanium (e.g., GeO₂), phosphorus (e.g., P₂O₅), aluminum (e.g. Al₂O₃), chlorine, or an alkali metal oxide (e.g. Na₂O, K₂O, Li₂O, Cs₂O, or Rb₂O). In some embodiments, the core comprises germanium doped glass having a germanium concentration between about 4 wt. % and about 8 wt. %. In embodiments where the core is doped with an alkali dopant, the peak concentration of the alkali in the silica glass may range from about 10 ppm to about 500 ppm, or from about 30 ppm to about 400 ppm. In yet other embodiments, the silica glass of core region 30 is free of germanium and/or chlorine; that is the core region comprises silica glass that lacks germanium and/or chlorine.

Down-doped silica glass includes silica glass doped with, for example, fluorine or boron.

As discussed above, the relative refractive index of core region 30 of glass fiber 20 is described by an α-profile with an α value that is in a range of about 20 or less, or about 18 or less, or about 16 or less, or about 15 or less, or about 14 or less, or about 12 or less, or about 10 or less, or about 8 or less, or about 6 or less, or about 5 or less, or about 4 or less, or about 3 or less, or about 2 or less. Additionally or alternatively, the α value is about 5 or greater, or about 6 or greater, or about 7 or greater, or about 8 or greater, or about 9 or greater, or about 10 or greater, or about 11 or greater, or about 12 or greater. In some embodiments, the α value is in a range from about 2 to about 20, or about 4 to about 18, or about 6 to about 14, or about 6 to about 10, or about 5 to about 12.

The outer radius r₁ of core region 30 is in a range from about 3.0 microns to about 7.0 microns, or about 3.5 microns to about 6.5 microns, or about 4.0 microns to about 5.0 microns, or about 4.0 microns to about 4.6 microns, or about 4.2 microns to about 5.3 microns. In some embodiments, the outer radius r₁ is about 4.2 microns, or about 4.3 microns, or about 4.4 microns, or about 4.5 microns, or about 5.3 microns, or about 5.4 microns, or about 5.5 microns, or about 5.6 microns.

The maximum relative refractive index Δ₀ or Δ₁ₘₐₓ of core region 30 is in a range from about 0.50% or less, or about 0.40% or less, or about 0.39% or less, or about 0.38% or less, or about 0.37% or less, or about 0.36% or less, or about 0.35% or less, or about 0.34% or less, or about 0.33% or less, or about 0.32% or less, or about 0.30% or less, or about 0.28% or less. Additionally or alternatively, the maximum relative refractive index Δ₀ or Δ₁ₘₐₓ of core region 30 is about 0.10% or greater, or about 0.15% or greater, or about 0.20% or greater, or about 0.25% or greater, or about 0.28% or greater, or about 0.30% or greater. In some embodiments, the maximum relative refractive index Δ₀ or Δ₁ₘₐₓ is in a range from about 0.15% to about 0.50%, or about 0.20% to about 0.45%, or about 0.25% to about 0.40%, or about 0.25% to about 035%, or about 0.25% to about 0.40%, or about 0.25% to about 0.40%, or about 0.28% to about 0.40%, or about 0.28% to about 0.38%, or about 0.28% to about 0.36%, or about 0.28% to about 0.34%, or about 0.28% to about 0.30%.

Although not depicted in FIG. 3, in some embodiments, the relative refractive index of core region 30 may have a centerline dip such that the maximum refractive index of core region 30 and the maximum refractive index of the entire optical fiber 10 is located a small distance away from the centerline of core region 30 rather than at the centerline of core region 30, as depicted in FIG. 3.

Core region 30 may have a core volume V₁ from about 4.0% Δ-micron² to about 6.0% Δ-micron², or about 4.2% Δ-micron² to about 5.8% Δ-micron², or about 4.4% Δ-micron² to about 5.6% Δ-micron², or about 4.5% Δ-micron² to about 5.5% Δ-micron², or about 4.5% Δ-micron² to about 5.0% Δ-micron², or about 4.5% Δ-micron² to about 6.0% Δ-micron², or about 4.5% Δ-micron² to about 5.0% Δ-micron²

### Inner Cladding Region

Inner cladding region 42 may be comprised of un-doped silica glass. The inner radius of inner cladding region 42 is r₁, as discussed above. The outer radius r₂ of inner cladding region 42 is in a range from about 6.0 microns to about 14.0 microns, or about 6.5 microns to about 13.5 microns, or about 7.0 microns to about 13.0 microns, or about 7.5 microns to about 12.5 microns, or about 8.0 microns to about 12.0 microns, or about 8.5 microns to about 10.5 microns, or about 8.5 microns to about 10.0 microns. In some embodiments, the outer radius r₂ is about 7.5 microns, or about 8.5 microns, or about 8.9 microns, or about 9.0 microns, or about 10.2 microns.

The relative refractive index Δ₂ of inner cladding region 42 is in a range from about −0.20% to about 0.20%, or in a range from about −0.15% to about 0.15%, or in a range from about −0.10% to about 0.10%, or in a range from about −0.05% to about 0.05%. In some embodiments, the relative refractive index Δ₂ is about 0.0%. The relative refractive index Δ₂ is preferably constant or approximately constant.

A ratio of radius r₁ to radius r₂ (r₁/r₂) may be in a range from about 0.3 to about 0.6, or about 0.4 to about 0.5, or about 0.3 to about 0.5, or about 0.4 to about 0.6. The ratio of radius r₁ to radius r₂ should preferably be less than about 0.6 in order to achieve low bend loss and to ensure that the zero dispersion wavelength is between 1300 nm and 1324 nm.

It is also noted that in some embodiments, the optical fibers disclosed herein do not comprise inner cladding region 42. Instead, in these embodiments, depressed-index cladding region 43 is positioned directly adjacent to core region 30.

### Depressed-Index Cladding Region

Depressed-index cladding region 43 comprises down-doped silica glass. In some embodiments, depressed-index cladding region 43 is down-doped with fluorine or boron. However, the down-doping of depressed-index cladding region 43 can also be accomplished by incorporating voids in silica glass.

The inner radius of depressed-index cladding region 43 is r₂, as discussed above. The outer radius r₃ of depressed-index cladding region 43 is in a range from about 8 microns to about 20 microns, or about 10 microns to about 18 microns, or about 12 microns to about 16 microns, or about 12 microns to about 15 microns, or about 10 microns to about 15 microns. In some embodiments, the outer radius r₃ is about 12.5 microns, or about 13.9 microns, or about 14.9 microns, or about 15.2 microns, or about 16.3 microns.

In some embodiments, depressed-index cladding region 43 is a depressed-index cladding region that forms a trench design. The trench design may be an offset trench. The minimum relative refractive index Δ₃ (Δ_{3MIN}) of depressed-index cladding region 43 is about −0.20% or less, or about −0.22% or less, or about −0.25% or less, or about −0.28% or less, or about −0.30% or less, or about −032% or less, or about −0.35% or less, or about −0.38% or less, or about −0.40% or less, or in a range from about −0.20% to about −0.60%, or about −0.25% to about −0.55%, or about −0.30% to about −0.50%, or about −0.35% to about −0.45%, or about −0.35% to about −0.48%. In some embodiments, the minimum relative refractive index Δ₃ of depressed index cladding region 43 is about −0.39%, or about −0.43%, or about −0.46%, or about −0.47%.

The transition region from inner cladding region 42 to depressed-index cladding region 43 is shown as a step change in FIG. 3. Furthermore, the transition region from depressed-index cladding region 43 to outer cladding region 44 is shown as a step change in FIG. 3. However, it is to be understood that the step changes are each an idealization and that the transition regions may not be strictly vertical in practice. Instead, the transition regions may each have a slope or curvature.

Depressed-index cladding region 43 may have a square profile, as shown in FIG. 3. However, it is contemplated that depressed-index cladding region 43 may have other profile configurations.

Using equation (6) above, a “volume” V₃ of depressed-index cladding region 43 is defined in equation (9) as:

$${V}_{3} = 2 {\int }_{r 2}^{r 3} {Δ}_{3 - 5} rdr \qquad ( 9 )$$

where Δ₃₋₅=(Δ₃(r)−Δ₅).

The trench volume V₃ of depressed-index cladding region 43 may be about −20% Δ-micron² to about −60% Δ-micron², or about −20% Δ-micron² to about −50% Δ-micron², or about −25% Δ-micron² to about −55% Δ-micron², or about −30% Δ-micron² to about −50% Δ-micron², or about −32% Δ-micron² to about −48% Δ-micron². In some embodiments, the trench volume V₃ is about −34% Δ-micron², or about −38% Δ-micron², or about −44% Δ-micron², or about −46% Δ-micron².

Without intending to be limited by theory, the offset trench design, with the trench volumes disclosed herein, provides the low bend loss values disclosed herein. It is noted that such low bend loss is able to be achieved at the relatively large mode field diameter values disclosed herein. Additionally, the location of depressed-index cladding region 43 is optimized to maintain the low cable cutoff values disclosed herein and to ensure that the zero dispersion wavelength is between 1300 nm and 1324 nm.

### Outer Cladding Region

Outer cladding region 44 may be comprised of un-doped silica glass. The inner radius of outer cladding region 44 is r₃, as discussed above. The outer radius r₄ of outer cladding region 44 is in a range from about 40.0 microns to about 65 microns, or from about 45.0 microns to about 62.5 microns, or from about 50.0 microns to about 60.0 microns, or from about 52.5 microns to about 57.5 microns. In some embodiments, the outer radius r₄ of outer cladding region 44 is about 62.5 microns.

The relative refractive index Δ₄ of outer cladding region 44 is in a range from about −0.20% to about 0.20%, or in a range from about −0.15% to about 0.15%, or in a range from about −0.10% to about 0.10%, or in a range from about −0.05% to about 0.05%. In some embodiments, the relative refractive index Δ₄ is about 0.0%. The relative refractive index Δ₄ is preferably constant or approximately constant. Furthermore, in some embodiments, the relative refractive index Δ₄ is equal to or substantially equal to the relative refractive index Δ₂.

### Outer Coatings

Primary coating 50 immediately surrounds glass fiber 20, and secondary coating 60 immediately surrounds primary coating 50. In some embodiments, primary coating 50 comprises a low modulus material and secondary coating 60 comprises a high modulus material. One or more of the materials may be, for example, acrylate.

Optical fiber 10 may also include a tertiary coating that surrounds secondary coating 60. The tertiary coating may include pigments, inks, or other coloring agents to mark the optical fiber for identification purposes and typically has a Young's modulus similar to the Young's modulus of the secondary coating.

An outer diameter of secondary coating 60 is an outer diameter of optical fiber 10, when a tertiary layer is not applied. The outer diameter of secondary coating 60 may be about 250 microns or less, or about 220 microns or less, or about 210 microns or less, or about 200 microns or less, or about 190 microns or less, or about 180 microns or less, or about 170 microns or less.

### Properties

The optical fibers disclosed herein have advantageous properties of balancing low cable cutoff with a large mode field diameter and low bend loss. The low cable cutoff allows 2 m or shorter lengths of the fibers disclosed herein to be single-mode at 1260 nm with low multipath interference. The large mode field diameter allows the fibers disclosed herein to have low coupling loss when coupled to a transceiver and to have high compatibility with standard single-mode fibers having a mode field diameter at 1310 nm in the range from 8.6 to 9.5 microns. Furthermore, the low bend loss allows the fibers disclosed herein to be routed around tight curvatures with diameters as small as 10 mm without incurring more than 2 dB of induced loss.

With regard to the bend loss, the optical fibers disclosed herein meet the G.657.A1 standard, exhibiting a bend loss less than 0.75 dB/turn at a wavelength of 1550 nm when wrapped around a 20 mm diameter mandrel. Some embodiments of the optical fibers disclosed herein also meet the G.657.A2 standard, exhibiting a bend loss less than 0.5 dB/turn at a wavelength of 1550 nm when wrapped around a 15 mm diameter mandrel. It is noted that these bend loss standards are achieved while maintaining a large mode field diameter, in contrast to conventional fibers.

The optical fibers disclosed herein have a bend loss at 1310 nm, as determined by the mandrel wrap test having a diameter of 15 mm, of less than about 1.00 dB/turn, or less than about 0.75 dB/turn, or less than about 0.50 dB/turn, or less than about 0.40 dB/turn, or less than about 0.25 dB/turn, or less than about 0.20 dB/turn, or less than about 0.15 dB/turn, or less than about 0.14 dB/turn, or less than about 0.13 dB/turn, or less than about 0.12 dB/turn, or less than about 0.11 dB/turn, or less than about 0.10 dB/turn, or less than about 0.09 dB/turn, or less than about 0.08 dB/turn, or less than about 0.07 dB/turn, or less than about 0.06 dB/turn, or less than about 0.05 dB/turn.

Additionally, the optical fibers disclosed herein have a bend loss at 1310 nm, as determined by the mandrel wrap test having a diameter of 10 mm, of less than about 2.00 dB/turn, or less than about 1.50 dB/turn, or less than about 1.00 dB/turn, or less than about 0.50 dB/turn, or less than about 0.40 dB/turn, or less than about 0.30 dB/turn, or less than about 0.28 dB/turn, or less than about 0.26 dB/turn, or less than about 0.24 dB/turn, or less than about 0.22 dB/turn, or less than about 0.20 dB/turn, or less than about 0.18 dB/turn, or less than about 0.16 dB/turn, or less than about 0.14 dB/turn, or less than about 0.12 dB/turn, or less than about 0.10 dB/turn.

Additionally, the optical fibers disclosed herein have a bend loss at 1550 nm, as determined by the mandrel wrap test having a diameter of 15 mm, of less than about 2.00 dB/turn, or less than about 1.75 dB/turn, or less than about 1.50 dB/turn, or less than about 1.25 dB/turn, or less than about 1.00 dB/turn, or less than about 0.75 dB/turn.

Additionally, the optical fibers disclosed herein have a bend loss at 1550 nm, as determined by the mandrel wrap test having a diameter of 10 mm, of less than about 4.00 dB/turn, or less than about 3.50 dB/turn, or less than about 3.00 dB/turn, or less than about 2.50 dB/turn, or less than about 2.00 dB/turn, or less than about 1.50 dB/turn.

In addition to the low bend losses disclosed above, the optical fibers disclosed herein also have a mode field diameter, at 1310 nm wavelength, of about 8.4 microns or greater, or about 8.6 microns or greater, or about 8.8 microns or greater, or about 8.9 microns or greater, or about 9.0 microns or greater, or about 9.1 microns or greater, or about 9.2 microns or greater, or about 9.3 microns or greater, or about 9.4 microns or greater, or about 9.5 microns or greater, or about 9.6 microns or greater. In some embodiments, the mode field diameter is in a range from about 8.4 microns to about 9.7 microns, or from about 8.6 microns to about 9.5 microns, or from about 8.8 microns to about 9.4 microns, or from about 9.0 microns to about 9.4 microns. For example, the mode field diameter, at 1310 nm wavelength, is about 8.88 microns, or about 8.90 microns, or about 8.91 microns, or about 9.22 microns, or about 9.34 microns.

The optical fibers disclosed herein have a mode field diameter, at 1550 nm wavelength, of about 9.2 microns to about 11.0 microns, or about 9.4 microns to about 10.8 microns, or about 9.8 microns to about 10.6 microns, or about 10.0 microns to about 10.4 microns, or about 9.8 microns to about 10.4 microns. In some embodiments, the mode field diameter, at 1550 nm wavelength, is about 9.90 microns, or about 10.09 microns, or about 10.10 microns, or about 10.24 microns, or about 10.31 microns.

The 22 m cable cutoff of the optical fibers disclosed herein is about 1200 nm or less, or about 1195 nm or less, or about 1190 nm or less, or about 1185 nm or less, or about 1180 nm or less, or about 1175 nm or less, or about 1170 nm or less, or about 1160 nm or less, or about 1150 nm or less, or about 1140 nm or less, or about 1140 nm or less, or about 1120 nm or less, or about 1110 nm or less, or about 1100 nm or less. For example, the 22 m cable cutoff is from about 1060 nm to about 1200 nm, or from about 1060 nm to about 1180 nm, or from about 1080 nm to about 1180 nm, or from about 1100 to about 1180 nm, or from about 1100 nm to about 1160 nm, or from about 1120 nm to about 1180 nm. In embodiments, the 22 m cable cutoff is about 1129 nm, or about 1133 nm, or about 1155 nm, or about 1178 nm.

The 2 m cable cutoff of the optical fibers disclosed herein is about 1260 nm or less, or about 1250 nm or less, or about 1240 nm or less, or about 1230 nm or less, or about 1220 nm or less, or about 1210 nm or less, or about 1200 nm or less, or about 1190 nm or less, or about 1180 nm or less, or about 1170 nm or less, or about 1160 nm or less, or about 1150 nm or less, or about 1140 nm or less, or about 1130 nm or less, or about 1120 nm or less. For example, the 2 m cable cutoff is from about 1120 nm to about 1260 nm, or about 1120 nm to about 1250 nm, or about 1120 nm to about 1240 nm, or about 1140 nm to about 1220 nm, or about 1160 nm to about 1200 nm, or about 1180 nm to about 1260 nm, or about 1190 nm to about 1260 nm, or about 1200 nm to about 1250 nm, or about 1200 nm to about 1240 nm, or about 1210 nm to about 1250 nm. In embodiments, the 2 m cable cutoff is about 1195 nm, or about 1198 nm, or about 1205 nm, or about 1222 nm.

The 1 m cable cutoff of the optical fibers disclosed herein is about 1260 nm or less, or about 1250 nm or less, or about 1240 nm or less, or about 1230 nm or less, or about 1220 nm or less, or about 1210 nm or less, or about 1200 nm or less, or about 1190 nm or less, or about 1180 nm or less, or about 1170 nm or less, or about 1160 nm or less, or about 1150 nm or less, or about 1140 nm or less. For example, the 1 m cable cutoff is from about 1140 nm to about 1260 nm, or about 1140 nm to about 1250 nm, or about 1140 nm to about 1240 nm, or about 1140 nm to about 1220 nm, or about 1140 nm to about 1200 nm, or about 1190 nm to about 1270 nm, or about 1200 nm to about 1260 nm, or about 1200 nm to about 1250 nm, or about 1200 nm to about 1240 nm, or about 1210 nm to about 1250 nm. In embodiments, the 1 m cable cutoff is about 1195 nm, or about 1198 nm, or about 1205 nm, or about 1222 nm.

The MAC value of an optical fiber is used to determine the bend sensitivity of the fiber. It is the ratio of mode field diameter (converted to nm) to the 22 m cable cutoff (nm). Smaller MAC values advantageously result in low bending loss. It is noted that the MAC value will decrease if mode field diameter is decreased and/or if cable cutoff is increased. In the embodiments disclosed herein, the optical fibers have MAC values at 1550 nm from about 6.0 to about 8.0, or about 6.2 to about 7.8, or about 6.4 to about 7.6, or about 6.6 to about 7.6, or about 6.8 to about 7.6, or about 7.0 to about 7.6, or about 7.2 to about 7.6, or about 6.8 to about 8.0. In embodiments, the MAC value at 1550 nm is about 6.92, or about 7.01, or about 7.43, or about 7.42, or about 7.53.

Furthermore, the optical fibers disclosed herein have an effective area, at 1310 nm wavelength, of about 60.0 micron² or greater, or about 62.0 micron² or greater, or about 64.0 micron² or greater, or about 66.0 micron² or greater, or about 70.0 micron² or less, or about 69.0 micron² or less, or about 68.0 micron² or less, or about 67.0 micron² or less, or about 66.0 micron² or less, or about 65.0 micron² or less, or about 64.0 micron² or less. In some embodiments, the effective area, at 1310 nm wavelength, is in range between about 60 micron² and about 70 micron², or about 62 micron² to about 68 micron², or about 64 micron² to about 66 micron². The optical fibers also have an effective area, at 1550 nm wavelength, of about 75 micron² or greater, or about 78 micron² or greater, or about 80 micron² or greater, or about 82 micron² or greater, or about 85 micron² or greater, or about 87 micron² or greater. Additionally or alternatively, the effective area, at 1550 nm wavelength, is about 95 micron² or less, or about 90 micron² or less, or about 85 micron² or less. In some embodiments, the effective area, at 1550 nm wavelength, is in range between about 75 micron² and about 90 micron².

The optical fibers disclosed herein also have zero dispersion wavelength (λ₀) from about 1290 nm to about 1330 nm. For example, the zero dispersion wavelength can be from about 1295 nm to about 1325 nm, about 1300 nm to about 1324 nm, or from about 1305 nm to about 1315 nm. For example, the zero dispersion wavelength can be about 1280 nm, about 1285 nm, about 1289 nm, about 1290 nm, about 1300 nm, about 1301 nm, about 1305 nm, about 1306 nm, about 1310 nm, about 1315 nm, or about 1320 nm.

Additionally, the attenuation of the optical fibers disclosed herein is less than or equal to about 0.35 dB/km at 1310 nm wavelength, less than or equal to about 0.2 dB/km at 1550 nm wavelength, and less than or equal to about 0.2 dB/km at 1625 nm wavelength. In some embodiments, the attenuation is less than or equal to about 0.19 dB/km, or less than or equal to about 0.18 dB/km, or less than or equal to about 0.185 dB/km at 1550 nm wavelength. In some embodiments, the attenuation is less than or equal to about 0.34 dB/km, or less than or equal to about 0.33 dB/km, or less than or equal to about 0.32 dB/km at 1310 nm wavelength.

According to aspects of the present disclosure, the optical fibers have a dispersion at 1310 nm in a range between about −1.5 ps/nm/km and about 1.5 ps/nm/km and a dispersion slope at 1310 nm in a range between about 0.05 ps/nm²/km and 0.1 ps/nm²/km. For example, the dispersion at 1310 nm is from about −1.2 ps/nm/km to about 1.2 ps/nm/km, or about −1.0 ps/nm/km to about 1.0 ps/nm/km. For example, the dispersion at 1310 nm is about −1.1 ps/nm/km, or about −0.8 ps/nm/km, or about −0.7 ps/nm/km, or about −0.4 ps/nm/km, or about −0.3 ps/nm/km, or about 0.1 ps/nm/km, or about 0.2 ps/nm/km. In some examples, the dispersion slope at 1310 nm is about 0.05 ps/nm²/km to about 0.095 ps/nm²/km, or about 0.06 ps/nm²/km to about 0.1 ps/nm²/km, about 0.07 ps/nm²/km to about 0.1 ps/nm²/km, about 0.08 ps/nm²/km to about 0.1 ps/nm²/km.

Disclosed embodiments of the optical fiber allow for single-mode operation at a deployment length of 5 m or less at wavelengths less than 1260 nm, less than 1200 nm or even less than 1140 nm. Disclosed embodiments of the optical fiber allow for single-mode operation at a deployment length of 2 m or less at wavelengths less than 1260 nm, less than 1200 nm or even less than 1140 nm. Disclosed embodiments of the optical fiber allow for single-mode operation at a deployment length of 1 m or less at wavelengths less than 1260 nm, less than 1200 nm, or even less than 1140 nm. Disclosed embodiments of the optical fiber allow for single-mode operation at a deployment length of 0.5 m or less at wavelengths less than 1260 nm, less than 1200 nm, or even less than 1140 nm.

### Exemplary Embodiments

Provided below are exemplary embodiments of the optical fibers disclosed herein. The below examples are intended to be exemplary and are not intended to limit the scope of the disclosure.

Table 1 below provides two exemplary embodiments, each with a square depressed-index cladding region according to aspects of the present disclosure. As shown below in Table 1, the fibers of Exemplary Examples 1 and 2 both have low cable cutoff and low bend loss coupled with a relatively large mode field diameter.

TABLE 1

| | Exemplary | Exemplary |
|---|---|---|
| | Example 1 | Example 2 |
| Core Region Maximum Relative Refractive | 0.34 | 0.32 |
| Index, Δ₁ₘₐₓ (%) | | |
| Core Region Radius, r₁ (microns) | 4.35 | 4.35 |
| Core Region Alpha | 6 | 7 |
| Core Region Volume, V₁ (% Δ-micron²) | 4.9 | 4.9 |
| Inner Cladding Region Relative Refractive | 0.0 | 0.0 |
| Index, Δ₂ (%) | | |
| Inner Cladding Region Radius, R₂ (microns) | 9.3 | 9.3 |
| R₁/R₂ | 0.47 | 0.47 |
| Depressed-Index Cladding Region Shape | Square | Square |
| Depressed-Index Cladding Region Minimum | −0.415 | −0.4 |
| Relative Refractive Index, Δ₃ₘᵢₙ (%) | | |
| Depressed-Index Cladding Region Radius, | 13.8 | 13.8 |
| R₃ (microns) | | |
| Volume of Depressed-Index Cladding | −40.4 | −42.8 |
| Region, V₃ (% Δ-micron²) | | |
| Outer Cladding Region Index, Δ₄ (%) | 0.0 | 0.0 |
| Outer Cladding Region Radius, R₄ (microns) | 62.5 | 62.5 |
| Mode Field Diameter at 1310 nm (microns) | 8.96 | 9.12 |
| Mode Field Diameter at 1550 nm (microns) | 10.08 | 10.25 |
| Dispersion at 1320 nm (ps/nm/km) | 0.14 | 0.36 |
| Dispersion Slope (ps/nm²/km) | 0.091 | 0.092 |
| Zero Dispersion Wavelength (nm) | 1308.4 | 1306.1 |
| 22 m Cable Cutoff (nm) | 1188 | 1171 |
| 2 m Cable Cutoff (nm) | 1253 | 1236 |
| MAC Value | 7.15 | 7.38 |
| 15 mm Diameter Bend Loss at 1310 nm | 0.06 | 0.08 |
| (dB/turn) | | |
| 15 mm Diameter Bend Loss at 1550 nm | 0.50 | 1.25 |
| (dB/turn) | | |

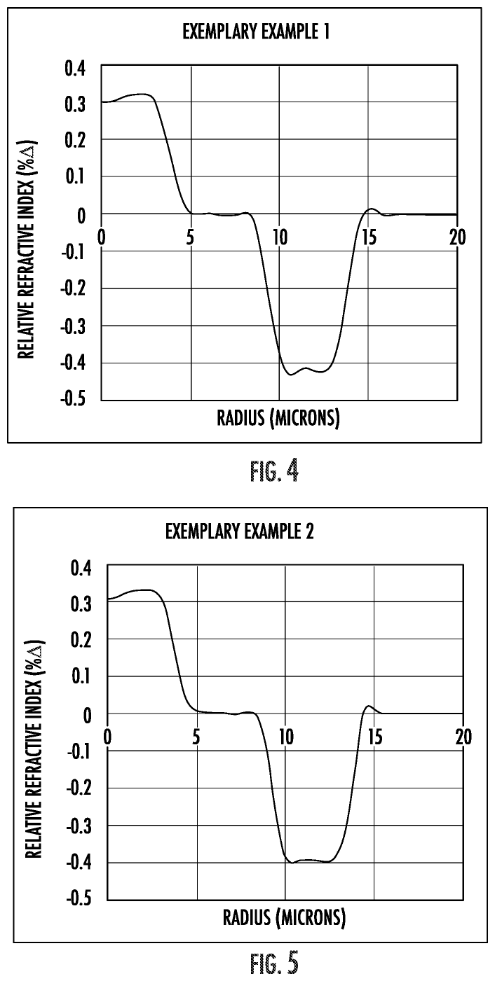

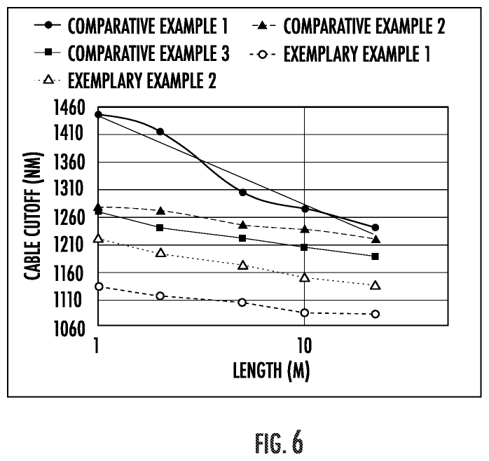

FIG. 4 shows the relative refractive index profile for Exemplary Example 1, and FIG. 5 shows the refractive index profile for Exemplary Example 2. Furthermore the cable cutoff of Exemplary Examples 1 and 2 were plotted as a function of fiber length, as shown in FIG. 6. Additionally, the cable cutoff values of three comparative fibers (Comparative Examples 1, 2, and 3) are also shown in FIG. 6. Comparative Example 1 comprises a fiber having a step-index core surrounded by an offset trench that has a relatively high volume of about −71% Δ-micron². This large trench volume inhibits the ability of the higher order modes to escape into the cladding region, and as a result, the fiber is not single-mode at 1260 nm for deployment lengths that are 2 m or less. Comparative Example 2 comprises a fiber having a graded-index core surrounded by a depressed index trench that has a volume of only −3.4% Δ-micron². This trench volume is too small to enable low bend-loss at bend diameters of 15 mm or less. Comparative Example 3 comprises a fiber having a graded-index core with a relatively high volume of about 5.9% Δ-micron², which is too large to enable the fiber to be single-mode at 1260 nm for deployment lengths that are 2 m or less.

As shown in FIG. 6, both Exemplary Examples 1 and 2 provide cable cutoffs below 1260 nm for relatively short lengths (about 2 m) and below 1200 nm for relatively long lengths (about 22 m). Therefore, Exemplary Examples 1 and 2 are advantageous for use in co-packaged optic applications. In contrast, Comparative Example 1 has a 22 m cable cutoff above 1260 nm for lengths that are at least 10 m or shorter due to the large trench volume. Furthermore, the cable cutoff of Comparative Example 1 has a much greater dependence on length (noting that the cable cutoff of Comparative Example 1 increases quite rapidly for decreasing lengths less than 5 m) than either of Exemplary Fibers 1 and 2. Comparative Example 2 has a 22 m cable cutoff wavelength less than 1260 nm but, the cable cutoff wavelength is greater than 1260 nm for lengths that are 2 m or shorter. In addition, the macrobend losses at a bend diameter of 15 mm are 11.4 dB/turn at 1550 nm and 0.3 dB/turn at 1310 nm, which are too high to enable the fiber to be routed in the confined footprints of co-packaged optic devices without resulting in excess loss. Comparative Example 3 has a 22 m cable cutoff wavelength less than 1260 nm for relatively longer lengths, but the 1 m cable cutoff wavelength is greater than 1260 nm. This can result in high levels of MPI in the 1260-1360 nm wavelength range when this fiber is used in applications that are 1 m or shorter in length.

Table 2 below provides four exemplary embodiments, each with a square depressed-index cladding region according to aspects of the present disclosure. As shown below in Table 2, the fibers of Exemplary Examples 3-6 all have low cable cutoff and low bend loss coupled with a relatively large mode field diameter.

TABLE 2

| | Exemplary | Exemplary | Exemplary | Exemplary |
|---|---|---|---|---|
| | Example 3 | Example 4 | Example 5 | Example 6 |
| Core Region Maximum Relative | 0.323 | 0.317 | 0.343 | 0.308 |
| Refractive Index, Δ₁ₘₐₓ (%) | | | | |
| Core Region Radius, R₁ (microns) | 4.22 | 4.38 | 4.12 | 4.46 |
| Core Region Alpha | 7.41 | 7.15 | 6.90 | 8.11 |
| Core Region Volume, V₁ (% Δ | 4.53 | 4.75 | 4.51 | 4.91 |
| -micron²) | | | | |
| Inner Cladding Region Relative | 0.0 | 0.0 | 0.0 | 0.0 |
| Refractive Index, Δ₂ (%) | | | | |
| Inner Cladding Region Radius, | 9.52 | 9.52 | 9.52 | 9.58 |
| R₂ (microns) | | | | |
| R₁/R₂ | 0.44 | 0.46 | 0.43 | 0.47 |
| Depressed-Index Cladding | Square | Square | Square | Square |
| Region Shape | | | | |
| Depressed-Index Cladding | −0.433 | −0.420 | −0.399 | −0.431 |
| Region Minimum Relative | | | | |
| Refractive Index, Δ₃ₘᵢₙ (%) | | | | |
| Depressed-Index Cladding | 14.30 | 14.04 | 13.71 | 14.23 |
| Region Outer Radius, R₃ | | | | |
| (microns) | | | | |
| Volume of Depressed-Index | −49.3 | −44.7 | −38.8 | −47.7 |
| Cladding Region, V₃ (% Δ- | | | | |
| micron²) | | | | |
| Outer Cladding Region Relative | 0.0 | 0.0 | 0.0 | 0.0 |
| Refractive Index, Δ₄ (%) | | | | |
| Outer Cladding Region Radius, | 62.5 | 62.5 | 62.5 | 62.5 |
| R₄ (microns) | | | | |
| Mode Field Diameter at 1310 nm | 9.04 | 9.16 | 8.84 | 9.29 |
| (microns) | | | | |
| Mode Field Diameter at 1550 nm | 10.21 | 10.30 | 10.02 | 10.42 |
| (microns) | | | | |
| Dispersion at 1310 nm | −0.14 | 0.27 | −0.63 | 0.60 |
| (ps/nm/km) | | | | |
| Dispersion Slope at 1310 nm | 0.092 | 0.092 | 0.091 | 0.092 |
| (ps/nm²/km) | | | | |
| Zero Dispersion Wavelength | 1311.6 | 1307.0 | 1316.9 | 1303.5 |
| (nm) | | | | |
| 22 m Cable Cutoff (nm) | 1149 | 1171 | 1151 | 1185 |
| 2 m Cable Cutoff (nm) | 1214 | 1236 | 1216 | 1250 |
| MAC Value | 7.44 | 7.41 | 7.27 | 7.43 |
| 15 mm Diameter Bend Loss at | 0.06 | 0.01 | 0.07 | 0.07 |
| 1310 nm (dB/turn) | | | | |
| 15 mm Diameter Bend Loss at | 1.33 | 1.26 | 1.22 | 1.22 |
| 1550 nm (dB/turn) | | | | |

FIG. 7 below shows the relative refractive index profile for Exemplary Example 5 and for Exemplary Example 6.

Table 3 below provides four exemplary embodiments, each with a square depressed-index cladding region according to aspects of the present disclosure. As shown below in Table 3, the fibers of Exemplary Examples 7-11 all have low cable cutoff and low bend loss coupled with a relatively large mode field diameter.

TABLE 3

| | Exemplary | Exemplary | Exemplary | Exemplary | Exemplary |
|---|---|---|---|---|---|
| | Example 7 | Example 8 | Example 9 | Example 10 | Example 11 |
| Core Region Maximum | 0.345 | 0.352 | 0.330 | 0.340 | 0.337 |
| Relative Refractive Index, | | | | | |
| Δ₁ₘₐₓ (%) | | | | | |
| Core Region Radius, R₁ | 4.25 | 4.44 | 4.48 | 4.17 | 4.36 |
| (microns) | | | | | |
| Core Region Alpha | 9.86 | 5.26 | 7.63 | 8.38 | 7.66 |
| Core Region Volume, V₁ | 5.19 | 5.04 | 5.25 | 4.77 | 5.08 |
| (% Δ-micron²) | | | | | |
| Inner Cladding Region | 0.0 | 0.0 | 0.0 | 0.0 | 0.0 |
| Relative Refractive Index, Δ₂ | | | | | |
| (%) | | | | | |
| Inner Cladding Region | 9.00 | 9.81 | 9.13 | 9.96 | 9.80 |
| Radius, R₂ (microns) | | | | | |
| R₁/R₂ | 0.47 | 0.45 | 0.49 | 0.42 | 0.45 |
| Depressed-Index Cladding | Square | Square | Square | Square | Square |
| Region Shape | | | | | |
| Depressed-Index Cladding | −0.379 | −0.449 | −0.429 | −0.396 | −0.382 |
| Region Minimum Relative | | | | | |
| Refractive Index, Δ₃ₘᵢₙ (%) | | | | | |
| Depressed-Index Cladding | 14.06 | 13.23 | 12.88 | 14.23 | 13.43 |
| Region Radius, R₃ (microns) | | | | | |
| Volume of Depressed-Index | −44.3 | −35.3 | −35.4 | −40.9 | −32.3 |
| Cladding Region, V₃ (% Δ- | | | | | |
| micron²) | | | | | |
| Outer Cladding Region | 0.0 | 0.0 | 0.0 | 0.0 | 0.0 |
| Index, Δ₄ (%) | | | | | |
| Outer Cladding Region | 62.5 | 62.5 | 62.5 | 62.5 | 62.5 |
| Radius, R₄ (microns) | | | | | |
| Mode Field Diameter at 1310 | 8.80 | 8.84 | 9.02 | 8.85 | 8.96 |
| nm (microns) | | | | | |
| Mode Field Diameter at 1550 | 9.89 | 10.03 | 10.11 | 10.08 | 10.14 |
| nm (microns) | | | | | |
| Dispersion at 1310 nm | 0.19 | −0.62 | 0.55 | −0.90 | −0.31 |
| (ps/nm/km) | | | | | |
| Dispersion Slope at 1310 nm | 0.091 | 0.091 | 0.092 | 0.090 | 0.090 |
| (ps/nm²/km) | | | | | |
| Zero Dispersion Wavelength | 1307.9 | 1316.8 | 1304.0 | 1320.0 | 1313.4 |
| (nm) | | | | | |
| 22 m Cable Cutoff (nm) | 1193 | 1178 | 1194 | 1158 | 1187 |
| 2 m Cable Cutoff (nm) | 1258 | 1243 | 1259 | 1224 | 1252 |
| MAC Value | 7.00 | 7.12 | 7.17 | 7.24 | 7.16 |
| 15 mm Diameter Bend Loss | 0.01 | 0.04 | 0.02 | 0.04 | 0.02 |
| at 1310 nm (dB/turn) | | | | | |
| 15 mm Diameter Bend Loss | 0.69 | 0.93 | 0.96 | 1.11 | 1.01 |
| at 1550 nm (dB/turn) | | | | | |

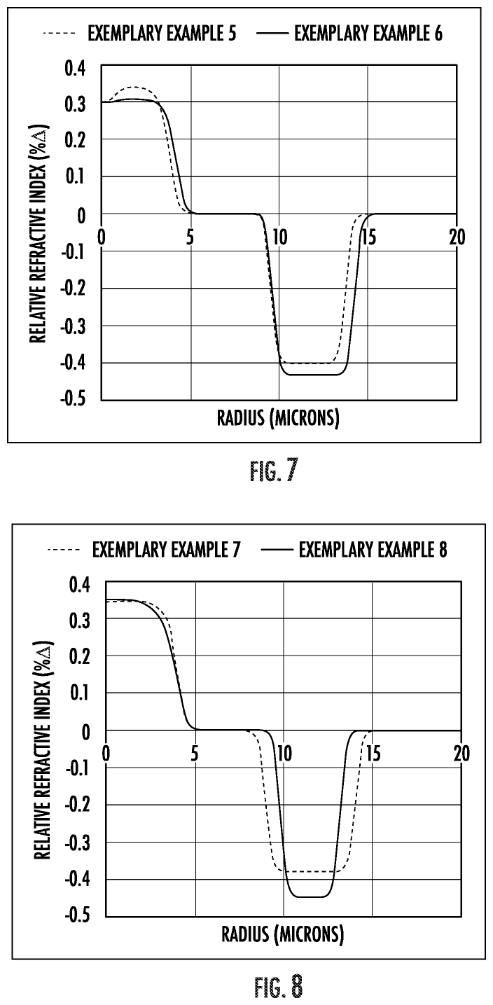

FIG. 8 shows the refractive index profile for Exemplary Example 7 and for Exemplary Example 8.

Table 4 below provides two exemplary embodiments, each with a square depressed-index cladding region according to aspects of the present disclosure. As shown below in Table 4, the fibers of Exemplary Examples 12 and 13 all have low cable cutoff and low bend loss coupled with a relatively large mode field diameter.

TABLE 4

| | Exemplary | Exemplary |
|---|---|---|
| | Example 12 | Example 13 |
| Core Region Maximum Relative | 0.333 | 0.332 |
| Refractive Index, Δ₁ₘₐₓ (%) | | |
| Core Region Radius, R₁ (microns) | 4.13 | 4.16 |
| Core Region Alpha | 7.93 | 7.90 |
| Core Region Volume, V₁ (% Δ- | 4.55 | 4.60 |
| micron²) | | |
| Inner Cladding Region Relative | 0.0 | 0.0 |
| Refractive Index, Δ₂ (%) | | |
| Inner Cladding Region Radius, R₂ | 9.63 | 9.47 |
| (microns) | | |
| R₁/R₂ | 0.43 | 0.44 |
| Depressed-Index Cladding Region | Square | Square |
| Shape | | |
| Depressed-Index Cladding Region | −0.439 | −0.391 |
| Minimum Relative Refractive | | |
| Index, Δ₃ₘᵢₙ (%) | | |
| Depressed-Index Cladding Region | 13.92 | 13.93 |
| Radius, R₃ (microns) | | |
| Volume of Depressed-Index | −44.4 | −40.7 |
| Cladding Region, V₃ (% Δ-micron²) | | |
| Outer Cladding Region Relative | 0.0 | 0.0 |
| Refractive Index, Δ₄ (%) | | |
| Outer Cladding Region Radius, | 62.5 | 62.5 |
| R₄ (microns) | | |
| 15 mm Diameter Bend Loss at | 8.88 | 8.90 |
| 1310 nm (dB/turn) | | |
| 15 mm Diameter Bend Loss at | 10.09 | 10.10 |
| 1550 nm (dB/turn) | | |
| Dispersion at 1310 nm (ps/nm/km) | −0.83 | −0.69 |
| Dispersion Slope at 1310 nm | 0.091 | 0.091 |
| (ps/nm²/km) | | |
| Zero Dispersion Wavelength (nm) | 1319.1 | 1317.6 |
| 22 m Cable Cutoff (nm) | 1129 | 1133 |
| 2 m Cable Cutoff (nm) | 1195 | 1198 |
| MAC Value | 7.43 | 7.42 |
| 15 mm Diameter Bend loss at | 0.56 | 0.91 |
| 1310 nm (dB/turn) | | |
| 15 mm Diameter Bend loss at | 1.45 | 1.47 |
| 1550 nm (dB/turn) | | |

Table 5 below provides three exemplary embodiments, each with a triangular depressed-index cladding region according to aspects of the present disclosure. As shown below in Table 5, the fibers of Exemplary Examples 14-16 all have low cable cutoff and low bend loss coupled with a relatively large mode field diameter.

TABLE 5

| | Exemplary | Exemplary | Exemplary |
|---|---|---|---|
| | Example | Example | Example |
| | 14 | 15 | 16 |
| Core Region Maximum Relative | 0.32 | 0.35 | 0.32 |
| Refractive Index, Δ₁ₘₐₓ (%) | | | |
| Core Region Radius, R₁ (microns) | 4.16 | 5.5 | 4.32 |
| Core Region Alpha | 12 | 2 | 12 |
| Core Region Volume, | 4.75 | 5.29 | 5.12 |
| V₁ (% Δ-micron²) | | | |
| Inner Cladding Region Relative | 0 | 0 | 0 |
| Refractive Index, Δ₂ (%) | | | |
| Inner Cladding Region Radius, | 7.2 | 6.8 | 6.7 |
| R₂ (microns) | | | |
| R₁/R₂ | 0.58 | 0.81 | 0.64 |
| Depressed-Index Cladding Region | Triangular | Triangular | Triangular |
| Shape | | | |
| Depressed-Index Cladding Region | −0.5 | −0.5 | −0.45 |
| Minimum Relative Refractive | | | |
| Index, Δ₃ₘᵢₙ (%) | | | |
| Depressed-Index Cladding Region | 16 | 15.2 | 14.9 |
| Radius, R₃ (microns) | | | |
| Volume of Depressed-Index | −62 | −52 | −45 |
| Cladding Region, | | | |
| V₃ (% Δ-micron²) | | | |
| Outer Cladding Region Relative | 0 | 0 | 0 |
| Refractive Index, Δ₄ (%) | | | |
| Outer Cladding Region Radius, | 62.5 | 62.5 | 62.5 |
| R₄ (microns) | | | |
| Mode Field Diameter at | 8.94 | 9.27 | 8.99 |
| 1310 nm (microns) | | | |
| Mode Field Diameter at | 10.11 | 10.42 | 10.06 |
| 1550 nm (microns) | | | |
| Dispersion at 1310 nm (ps/nm/km) | −0.81 | −0.47 | −0.09 |
| Dispersion Slope at 1310 nm | 0.09 | 0.093 | 0.09 |
| (ps/nm²/km) | | | |
| Dispersion at 1550 nm (ps/nm/km) | 17.74 | 18.71 | 18.5 |
| Dispersion Slope at 1550 nm | 0.063 | 0.065 | 0.063 |
| (ps/nm²/km) | | | |
| Zero Dispersion Wavelength (nm) | 1319 | 1315 | 1311 |
| 22 m Cable Cutoff (nm) | 1132 | 1139 | 1141 |
| 2 m Cable Cutoff (nm) | 1197 | 1204 | 1206 |
| MAC Value | 7.47 | 7.70 | 7.45 |
| 15 mm Diameter Bend Loss at | 0.14 | 0.30 | 0.23 |
| 1550 nm (dB/turn) | | | |
| 20 mm Diameter Bend Loss at | 0.03 | 0.08 | 0.06 |
| 1550 nm (dB/turn) | | | |
| 30 mm Diameter Bend Loss at | 0.01 | 0.01 | 0.01 |
| 1550 nm (dB/turn) | | | |

Table 6 below provides five exemplary embodiments, each with a triangular depressed-index cladding region according to aspects of the present disclosure. As shown below in Table 6, the fibers of Exemplary Examples 17-21 all have low cable cutoff and low bend loss coupled with a relatively large mode field diameter.

TABLE 6

| | Exemplary | Exemplary | Exemplary | Exemplary | Exemplary |
|---|---|---|---|---|---|
| | Example | Example | Example | Example | Example |
| | 17 | 18 | 19 | 20 | 21 |
| Core Region Maximum | 0.335 | 0.335 | 0.34 | 0.335 | 0.335 |
| Relative Refractive Index, | | | | | |
| Δ₁ₘₐₓ (%) | | | | | |
| Core Region Radius, R₁ | 4.825 | 4.4 | 4.8 | 4.575 | 4.525 |
| (microns) | | | | | |
| Core Region Alpha | 6 | 6 | 6 | 6 | 6 |
| Core Region Volume, V₁ | 5.47 | 4.74 | 5.82 | 5.08 | 5.08 |
| (% Δ-micron²) | | | | | |
| Inner Cladding Region | 0.025 | 0 | 0.03 | 0 | 0.01 |
| Relative Refractive Index, | | | | | |
| Δ₂ (%) | | | | | |
| Inner Cladding Region | 7.5 | 6.8 | 7.5 | 7.5 | 7.5 |
| Radius, R₂ (microns) | | | | | |
| R₁/R₂ | 0.643 | 0.647 | 0.64 | 0.61 | 0.603 |
| Depressed-Index Cladding | Triangular | Triangular | Triangular | Triangular | Triangular |
| Region Shape | | | | | |
| Depressed-Index Cladding | −0.398 | −0.4 | −0.398 | −0.398 | −0.398 |
| Region Minimum Relative | | | | | |
| Refractive Index, Δ₃ₘᵢₙ (%) | | | | | |
| Depressed-Index Cladding | 17 | 15.48 | 17 | 17 | 17 |
| Region Radius, R₃ | | | | | |
| (microns) | | | | | |
| Volume of Depressed-Index | −52.4 | −43.5 | −52.4 | −52.4 | −52.4 |
| Cladding Region, V₃ (% Δ- | | | | | |
| micron²) | | | | | |
| Outer Cladding Region | 0.0 | 0.0 | 0.0 | 0.0 | 0.0 |
| Relative Refractive Index, | | | | | |
| Δ₄ (%) | | | | | |
| Outer Cladding Region | 62.5 | 62.5 | 62.5 | 62.5 | 62.5 |
| Radius, R₄ (microns) | | | | | |
| Mode Field Diameter at | 9.15 | 8.89 | 9.10 | 9.01 | 9.01 |
| 1310 nm (microns) | | | | | |
| Mode Field Diameter at | 10.33 | 10.11 | 10.28 | 10.28 | 10.28 |
| 1550 nm (microns) | | | | | |
| Dispersion at 1310 nm | 0.111 | −0.781 | 0.114 | −0.82 | −0.82 |
| (ps/nm/km) | | | | | |
| Dispersion Slope at 1310 | 0.09 | 0.091 | 0.09 | 0.09 | 0.09 |
| nm (ps/nm\hat{ }2/km) | | | | | |
| Zero Dispersion | 1310 | 1319 | 1310 | 1321 | 1320 |
| Wavelength (nm) | | | | | |
| 22 m Cable Cutoff (nm) | 1145 | 1130 | 1137 | 1167 | 1131 |
| 2 m Cable Cutoff (nm) | 1210 | 1195 | 1202 | 1233 | 1197 |
| MAC Value | 7.56 | 7.44 | 7.57 | 7.31 | 7.53 |
| 15 mm Diameter Bend Loss | 0.59 | 0.37 | 0.74 | 0.07 | 0.49 |
| at 1310 nm (dB/turn) | | | | | |
| 15 mm Diameter Bend Loss | 1.39 | 1.43 | 1.44 | 1.02 | 1.42 |
| at 1550 nm (dB/turn) | | | | | |

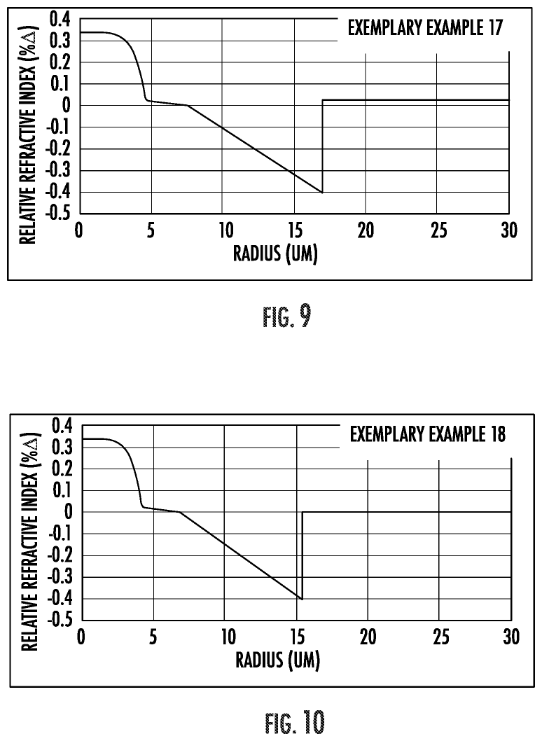

FIG. 9 shows the refractive index profile for Exemplary Example 17, and FIG. 10 shows the refractive index profile for Exemplary Example 18.

### Multi-Path Interference

Multi-path interference (MPI) is the propagation phenomenon that results when an optical signal reaches a destination via two or more optical paths. It provides a metric for quantifying single-mode behavior in fibers. The phenomenon of MPI may be observed when a short length of single-mode fiber that supports both the LP01 mode and the higher-order LP11 modes is connected or spliced between two system components such as, for example, a transceiver, switch, or another fiber with offsets in the connections. This phenomenon is described in Olivero, M., Greborio, L., Orta, R., Pellegrino, P., Perrone, G. and Regio, P., “Multipath Interference Characterization of Bend-Insensitive Optical Fibers and Short Jumpers,” Appl. Opt. vol. 55 no. 11, pp. 2998-3005 (10 Apr. 2016), which is incorporated herein by reference.

FIG. 11 shows an exemplary example of the MPI phenomenon wherein Fiber B is connected to both Fiber A and Fiber C with offsets between these connections. In the example of FIG. 11, a majority of the light from the LP01 mode of Fiber A (the input fiber) is coupled through the short length of Fiber B (the fiber-under-test) into the LP01 mode of Fiber C (the output fiber). However, at the connection between Fiber A and Fiber B, some of the light from the LP01 mode of Fiber A is coupled into the LP11 mode of Fiber B, and if the attenuation of the LP11 mode in Fiber B is low, a portion of the light in the LP11 mode in Fiber B will be coupled back to the LP01 mode of Fiber C. This light can interfere with the portion of the signal that propagates only in the LP01 mode and is coupled directly from Fiber A to Fiber C. When there is MPI, the output power will exhibit rapid sinusoidal oscillations with wavelength. The MPI penalty in a system, such as the system of FIG. 11, is calculated using equation (10):

$$MPI ( dB ) = 20 log [ 0.5 ( 1 {0}^{{Δ}_{PtP} ( dB ) / 10} - 1 ) / ( 1 {0}^{{Δ}_{PtP} ( dB ) / 10} + 1 ) ] \qquad ( 10 )$$

where Δ_{PtP} is the magnitude of the peak-to-peak oscillations of the transmission loss in dB. Table 7 illustrates the calculated MPI penalties for different values of Δ_{PtP}.

TABLE 7

| Δ_{PtP} | MPI |
|---|---|
| 0.05 | −50.8 |
| 0.1 | −44.8 |
| 0.15 | −41.3 |
| 0.2 | −38.8 |
| 0.25 | −36.8 |
| 0.3 | −35.3 |
| 0.35 | −33.9 |
| 0.4 | −32.8 |
| 0.45 | −31.7 |
| 0.5 | −30.8 |

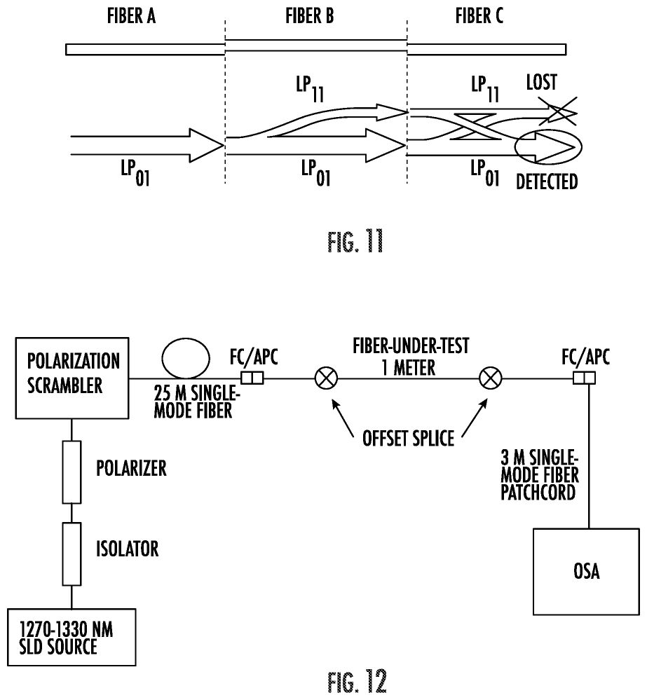

The MPI penalty of the fibers disclosed herein were calculated from the magnitudes of the peak-to-peak oscillations of the output power as measured using the experimental set-up shown in FIG. 12. As shown in FIG. 12, light from a superluminescent diode (SLD) source with a wavelength range of 1270-1330 nm was transmitted through an isolator, a polarizer and a polarization scrambler and then coupled into a 25 m length of single-mode fiber. This single-mode fiber has a 22 m cable cutoff less than 1260 nm, which enables it to function as a mode-filter to ensure that only the LP01 mode is coupled into the fiber-under-test (FUT). Offset splices at the input and output ends of the FUT were calibrated to yield 0.5 dB of loss, and the output signal was transmitted through a single-mode patchcord into an optical signal analyzer (OSA). The MPI penalty measurements were performed on 1 m lengths of the fibers deployed in straight configurations.

The output power versus wavelength was measured for Comparative Example 1, using the experimental set-up shown in FIG. 12, and is plotted in FIG. 13. The magnitude of the peak-to-peak oscillations of the output power is Δ_{PtP}=0.3 dB, which corresponds to a calculated MPI value of about −35 dB (using equation (10)).

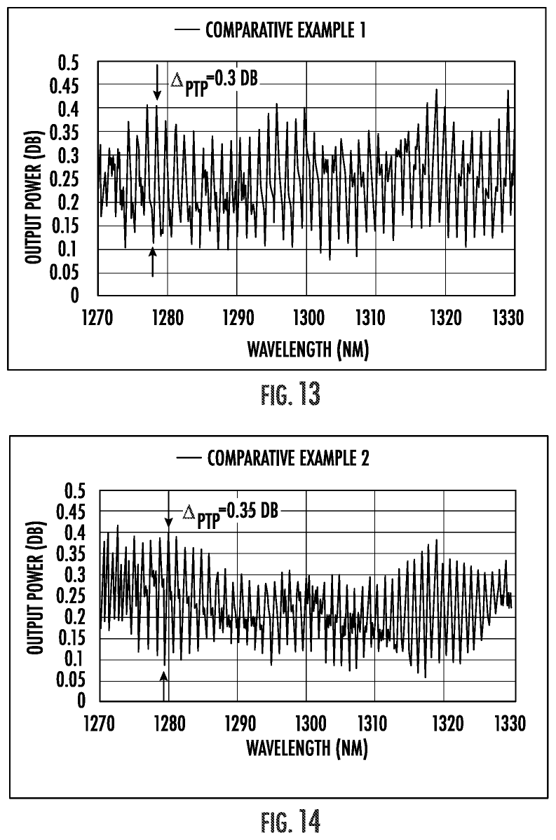

The output power versus wavelength was measured for Comparative Example 2, using the experimental set-up shown in FIG. 12, and is plotted in FIG. 14. The magnitude of the peak-to-peak oscillations of the output power is Δ_{PtP}=0.35 dB, which corresponds to a calculated MPI value of about −34 dB (using equation (10)).

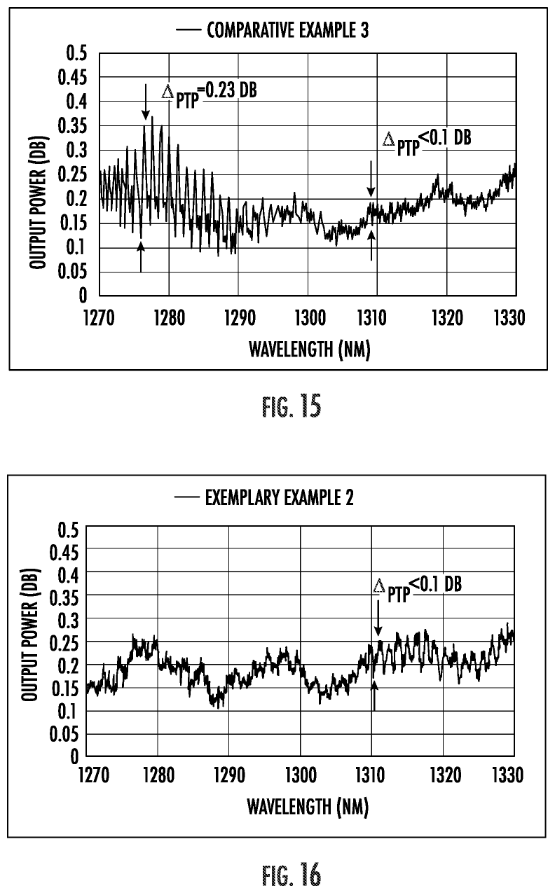

The output power versus wavelength was measured for Comparative Example 3, using the experimental set-up shown in FIG. 12, and is plotted in FIG. 15. The magnitude of the peak-to-peak oscillations of the output power Δ_{PtP} is between 0.2 and 0.25 dB at wavelengths between 1270 nm and 1290 nm, which corresponds to calculated MPI values in the −36 to −39 dB range (using equation (10)). However at longer wavelengths, the magnitude of the peak-to-peak oscillations of the output power Δ_{PtP} is less than 0.1 dB, which corresponds to MPI values less than about −45 dB.

The output power versus wavelength was measured for Exemplary Example 2, using the experimental set-up shown in FIG. 12, and is plotted in FIG. 16. The magnitude of the peak-to-peak oscillations of the output power Δ_{PtP} is less than 0.1 dB, which corresponds to MPI values less than about −45 dB (using equation (10)).

In embodiments disclosed herein, the fibers have a maximum MPI penalty, over a wavelength range from 1270 nm to 1330 nm, of about −30 dB or less, or about −35 dB or less, or about −40 dB or less, or about −45 dB or less, or about −50 dB or less, or about −55 dB or less, or about −60 dB or less. In embodiments, the fibers have a maximum MPI penalty, over the wavelength range from 1270 nm to 1330 nm, from about −30 dB to about −60 dB, or about −35 dB to about −55 dB, or about −40 dB to about −50 dB, or about −40 dB to about −60 dB, or about −45 dB to about −60 dB. In embodiments, the maximum MPI penalty values disclosed above are over a one meter length of the fiber.

### Integrated Systems and Optical Communication Systems

In addition to the low bend loss, low cable cutoff, and large mode field diameter optical fibers disclosed herein, the present disclosure extends to integrated systems that incorporate the fibers, and optical communication systems that employ the integrated systems.

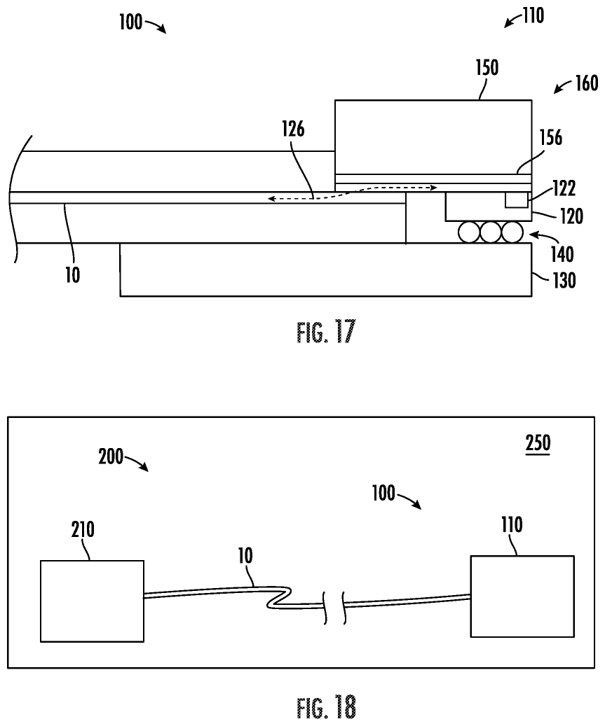

FIG. 17 is a side view of an example integrated system 100 that includes an example VCSEL-based transceiver 110 and fiber 10 as disclosed herein. The example transceiver 110 includes a photonic integrated circuit (PIC) 120 with an active device 122. The active device 122 may comprise a light source (e.g., LED, vertical cavity surface-emitting laser (VCSEL), distributed feedback (DFB) laser or semiconductor laser) and a light receiver (e.g., a photodetector). The PIC 120 is electrically connected to a printed circuit board (PCB) 130 via electrical connections 140 shown by way of example in the form of a ball-grid array. A waveguide structure 150 that includes at least one waveguide 156 is operably disposed adjacent PIC 120 so that light 126 emitted by a light-emitting active device 122 is coupled into the waveguide. The waveguide 156 is shown by way of example as being evanescently coupled to fiber 10 so that light 126 can couple between the waveguide and the fiber. The waveguide structure 150 and PIC 120 constitute a photonic device 160.

The active device 122 is coupled to the optical fiber 10. In one embodiment, the active device 122 operates at or near 1060 nm (e.g. 990 nm, 1015 nm, 1040 nm and/or 1064 nm). In an example, the active device 122 is a single-moded VCSEL. In another embodiment, the active device 122 operates at or near a wavelength of 1310 nm (e.g., 1260 nm-1360 nm). In an example, the active device 122 is a single-moded laser.

The integrated system 100 may also include peripheral devices such as modulators, detectors, multiplexers, demultiplexers, etc., as known in the art.

The low cutoff provided by fiber 10 reduces coupling losses between the fiber and waveguide 156 of photonic device 160 when an operating wavelength is less than 1080 nm. Conventional single-mode fibers have cable cutoff wavelengths above 1200 nm and are therefore multi-moded at wavelengths less than 1200 nm. Using these fibers in conjunction with lasers operating in the 980-1080 nm window can produce degradation of the signal integrity due to multi-path interference (MPI). While it is possible to strip out the LP11 and other higher order modes by wrapping the fiber around a small diameter mandrel, this can result in several dB of loss and is not effective with bend-insensitive fibers. It is therefore desirable to have a fiber that has a cable cutoff less than 1260 nm with a sufficiently high MFD to ensure low coupling losses, so that the fiber may also be used with transceivers that operate at wavelengths near 1310 nm. Advantageously, the embodiments of the optical fibers 10 described herein have a cable cutoff less than 1260 nm and a sufficiently high MFD (9.4 microns≥MFD≥8.8 microns), so that optical fibers 10 may be advantageously utilized with transceivers (transmitters and/or receivers) that operate at wavelengths near 1310 nm.

FIG. 18 is a schematic diagram of an example optical communication system 200 that includes the integrated system 100, with the fiber 10 thereof optically connected to a remote device 210. In an example, optical communication system 200 is deployed within a data center 250 and the remote device 210 is a data-center device, such as a server (e.g., rack-mounted server) or another data-center component such as a router, a switch, etc.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. An optical fiber comprising:
a silica-based core region comprising an alpha value less than 20, an outer radius r₁ from about 4.0 microns to about 4.6 microns, a maximum relative refractive index Δ_{1MAX} from about 0.28% to about 0.40%, and a core volume from about 4.5% Δ-micron² to about 5.5% Δ-micron²;
a depressed-index cladding region surrounding said core region, the depressed-index cladding region comprising an inner radius r₂ such that r₁/r₂ is greater than about 0.4 and less than about 0.6, an outer radius r₃, a minimum relative refractive index Δ_{3MIN} less than about −0.2%, and a trench volume between about −50% Δ-micron²s and about −20% Δ-micron²; and
an outer cladding region surrounding the depressed index cladding region, the outer cladding region comprising an outer radius r₄,
wherein the optical fiber comprises:
a mode field diameter at 1310 nm from about 8.8 microns to about 9.4 microns,
a 2 m cable cutoff from about 1120 nm to about 1260 nm,
a bending loss at 1310 nm, as determined by the mandrel wrap test using a mandrel comprising a diameter of 15 mm, of less than 1.0 dB/turn, and
a zero dispersion wavelength between 1300 nm and 1324 nm.

2. The optical fiber of claim 1, wherein the 2 m cable cutoff is from about 1120 nm to about 1240 nm.

3. The optical fiber of claim 2, wherein the 2 m cable cutoff is from about 1140 nm to about 1220 nm.

4. The optical fiber of claim 1, wherein a one meter length of the optical fiber has a maximum multi-path interference of about −35 dB or less over a wavelength range from 1270 nm to 1330 nm.

5. The optical fiber of claim 4, wherein a one meter length of the optical fiber has a maximum multi-path interference of about −40 dB or less over the wavelength range from 1270 nm to 1330 nm.

6. The optical fiber of claim 1, wherein the alpha value is greater than 5.

7. The optical fiber of claim 1, wherein the alpha value is less than 12.

8. The optical fiber of claim 1, wherein the mode field diameter at 1310 nm is from 8.8 microns to about 9.2 microns.

9. The optical fiber of claim 1, where r₁/r₂ is greater than about 0.4 and less than about 0.5.

10. The optical fiber of claim 1, wherein the maximum relative refractive index of the core region is from about 0.28% to about 0.38%.

11. The optical fiber of claim 1, wherein the trench volume is from about −50% Δ-micron² to about −30% Δ-micron².

12. The optical fiber of claim 11, wherein the trench volume is from about −48% Δ-micron² to about −32% Δ-micron².

13. The optical fiber of claim 1, wherein the core volume is from about 4.5% Δ-micron² to about 5.0% Δ-micron².

14. The optical fiber of claim 1, wherein the outer radius r₃ is from about 10 microns to about 18 microns.

15. The optical fiber of claim 1, wherein the outer radius r₃ is from about 12 microns to about 16 microns.

16. The optical fiber of claim 1, wherein the bending loss at 1310 nm, as determined by the mandrel wrap test using a mandrel comprising a diameter of 15 mm, is less than 0.75 dB/turn.

17. The optical fiber of claim 16, wherein the bending loss at 1310 nm, as determined by the mandrel wrap test using a mandrel comprising a diameter of 15 mm, is less than 0.50 dB/turn.

18. The optical fiber of claim 17, wherein the bending loss at 1310 nm, as determined by the mandrel wrap test using a mandrel comprising a diameter of 15 mm, is less than 0.40 dB/turn.

19. An integrated system comprising
the optical fiber according to claim 1; and
one or more vertical-cavity surface-emitting lasers (VCSELs) optically coupled to the optical fiber and that emits light at a wavelength between 980 nm and 1080 nm.

20. An integrated system comprising
the optical fiber according to claim 1; and
one or more lasers optically coupled to the optical fiber and that emits light at one or more wavelengths between 1260 nm and 1360 nm.
